(19) United States
(12) Patent Application Publication
(10) Pub. No.: US 2010/0277580 A1
(43) Pub. Date: Nov. 4, 2010

(54) MULTI-MODAL SPOT GENERATOR AND MULTI-MODAL MULTI-SPOT SCANNING MICROSCOPE

(75) Inventors: Sjoerd Stallinga, Eindhoven (NL); Dirk L.J. Vossen, Eindhoven (NL); Levinus P. Bakker, Eindhoven (NL); Bas Helsken, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., EINDHOVEN (NL)

(21) Appl. No.: 12/742,978

(22) PCT Filed: Nov. 19, 2008
(86) PCT No.: PCT/IB08/54861

§ 371 Date: Jul. 15, 2010

(30) Foreign Application Priority Data
Nov. 23, 2007 (EP) 07301571.1

(51) Int. Cl. H04N 7/18; G02B 27/09; G02B 27/10; G02B 21/06

(52) U.S. Cl. 348/79; 359/618; 359/385; 348/E07.085

(57) ABSTRACT

The invention relates to a spot generator (10) having: —an entrysurface (12) for receiving an incident light beam (20) and an exit surface (14) for (22, 24) transmitting the light beam, the entry surface defining an entryside (16) and the exit surface defining an exit side (18). According to the invention, the spot generator is designed to modulate the incident light beam to generate on the exit side a first plurality (22) and a second plurality (24) of separate light spots, each light spot belonging to the first plurality having a first angular spectrum and each light spot belonging to the second plurality having a second angular spectrum different than the first angular spectrum. Advantageously, the spot generator comprises a periodic binary phase structure. The invention further relates to a multi-spot scanning microscope and to a method of imaging a microscopic sample.

### FIELD OF THE INVENTION

The invention relates to a spot generator having:

an entry surface for receiving an incident light beam, and

an exit surface for transmitting the light beam,

the entry surface defining an entry side and the exit surface defining an exit side.

The invention also relates to a multi-spot scanning microscope and to a method of imaging a sample, in particular a microscopic sample.

### BACKGROUND OF THE INVENTION

Optical multi-spot scanning microscopes are used for producing images of, or example, a microscopic sample. The images are constructed by scanning the sample through an array of microscopic light spots generated by a spot generator of the microscope and by imaging the light spots on a detector (typically of photodetector). Such a microscope finds application in the field of life sciences, in particular for the inspection and investigation of biological specimens, digital pathology (i.e. pathology using digitalized images of microscopy slides), automated image-based diagnostics (e.g. for cervical cancer, malaria, and tuberculosis), as well as for industrial metrology.

Throughout this application, a light spot is defined as a spatial region where the intensity (i.e. the time-averaged energy-flux of the light field, of units W/m²), averaged over the region, is at least two times larger than in a surrounding region having a volume at least an order of magnitude larger than the volume of the light spot itself. Preferably, each light spot generated in the sample is diffraction-limited. Preferably, the intensity in the light spot is at least an order of magnitude higher than in the surrounding region.

U.S. Pat. No. 6,248,988 describes a multi-spot scanning optical microscope image acquisition system featuring an array of multiple separate focused light spots illuminating the object and the corresponding array detector detecting light from the object for each separate spot. Scanning the relative positions of the array and object at a slight angle to the rows of the spots allows an entire field of the object to be successively illuminated and imaged in a swath of pixels. Thereby the scanning speed is considerably augmented compared to a single-spot scanning microscope.

Existing multi-spot scanning microscope systems are adaptable to various imaging modes, including conventional and confocal imaging, transmissive and reflective viewing, bright field and phase contrast imaging, as well as two-dimensional and three-dimensional imaging. However, switching between different imaging modes is often cumbersome as it requires physical modification of the microscope assembly, such as exchanging the spot generator or mechanically readjusting the imaging optics.

It is therefore an object of the invention to provide a multi-spot scanning microscope that allows for easy and rapid switching between different imaging modes.

This object is achieved by the features of the independent claims. Further specifications and preferred embodiments of the invention are given in the dependent claims.

### SUMMARY OF THE INVENTION

The invention provides a spot generator having:

an entry surface for receiving an incident light beam, and

an exit surface for transmitting the light beam, the entry surface defining an entry side and the exit surface defining an exit side.

According to the invention, the spot generator is designed to modulate the incident light beam to generate on the exit side a first plurality and a second plurality of separate light spots, where light spots belonging to the same plurality have essentially the same angular spectrum and light spots belonging to different pluralities have different angular spectra. Namely, each light spot of the first and second plurality have respectively a first and second angular spectrum, and these first and second angular spectra are different with respect to each other.

Light spots belonging to different pluralities may additionally differ in their colour. Thus, the spots in one plurality all have essentially the same characteristics, except for to their positions and up to manufacturing tolerances, whereas light spots in two different pluralities differ. The term “angular spectrum” stands for a decomposition of light into plane waves. More precisely, the angular spectrum of a light spot stands for the angular dependence of the Fourier transform of the light spot's electromagnetic field, evaluated with the spatial coordinate systems having its origin at the centre of the light spot. By imaging the light spots on, e.g., a pixelated photodetector, various characteristics of the light spots can be measured, each characteristic giving rise to a different contrast modality. For example, the light's intensity integrated over a limited area surrounding the centres of the light spots yields the transmission contrast; the apparent displacement of the spot's intensity peak from its expected position gives the differential interference contrast and the intensity value at the centre of the nominal light spot gives the confocal contrast. By incorporating the spot generator in a microscope, the microscope can be made multi-modal, so that it has a first contrast mode in which the first plurality of spots is used and a second contrast mode in which the second plurality of spots is used. Of course, a single spot generator may provide more than two contrast modes. Switching between different contrast modes can be done in software by analyzing the detected light, which costs less time than mechanically changing optical elements.

It is considered advantageous that the light spots of the first plurality and the light spots of the second plurality lie in a common focal plane. This facilitates imaging the first plurality and the second plurality of light spots, especially if the depth of field of the imaging optics is limited.

In a preferred embodiment of the invention, every light spot generated on the exit side by the spot generator differs from every other light spot generated on the exit side by the spot generator in the projection of its position on a plane essentially perpendicular to the mean propagation direction of the transmitted light beam. The mean propagation direction is understood to be the weighted average over the propagation directions of the plane waves composing the light field on the exit side, where the weight factor is given by the light field's spectrum (i.e. its Fourier transform). In preferred embodiments, the mean propagation direction of the transmitted light beam coincides with the mean propagation direction of the incident light beam. The z-axis of a Cartesian x-y-z-coordinate system is conveniently chosen parallel to the mean propagation direction of the transmitted light beam. Thus, the light spots generated on the exit side by the spot generator have unique x-y-positions. This makes them easily identifiable in software upon detection on a photodetector.

In one embodiment, the spot generator comprises a first section for generating light spots of the first plurality and a second section for generating light spots of the second plurality. The wavelength for which the first section is adapted may differ from the wavelength for which the second section is adapted. However, it is often preferred that the light spots of the first plurality and the light spots of the second plurality have the same wavelength. The spot generator thus consists of parts, each part generating spots of a different class. A first part then generates spots of the first class on a first area of the object, which is then imaged onto a first area of the pixelated photodetector, and a second part generates spots of the second class on a second area of the object, which is then imaged onto a second area of the pixelated photodetector. Alternatively, the parts can be placed in alignment with the incident beam by mechanically translating the spot generator in a direction perpendicular to the incident beam. The different parts can be separate components assembled together in a holder, the assembly of holder and different parts then being the spot generator, or the different parts can form a monolithic component.

In an alternative embodiment, the spot generator comprises an array of identical unit cells for generating both the first and the second plurality of light spots. The first and the second pluralities of light spots thus take the form of two interlaced arrays. In the interlaced manner each unit cell generates at least two light spots such that at least two light spots differ in the angular spectrum of plane waves composing the spot. An advantage of this design is that the first array and the second array cover essentially the same region of the sample, making it easy to switch between the first and the second imaging mode for a selected portion of the sample.

In a preferred embodiment, the spot generator comprises a periodic binary phase structure. Preferably, the periodic binary phase structure is of the type proposed in WO 2006/035393. It consists of a periodic set of square unit-cells. The pattern of each unit-cell has two height values (hence the word binary), which simplifies manufacturing. The incident beam is diffracted into a large number of orders. These orders are collimated beams that travel in a certain direction. At the sample plane all these orders add up coherently to give an array of light spots. The amplitude and relative phase of these orders must be chosen correctly to make the desired spot. The design of such a structure mainly consists of finding a pattern for the unit-cell that gives rise to the correct amplitudes and phases of the diffraction orders. More precisely, the height profile can be derived from the desired spot design using the two-dimensional formula given in WO 2006/035393. Preferably, the height difference between the two height levels is adjusted to give a phase difference of π (modulo 2π) for all wavelengths that are used. This has the advantage of ease of manufacturing. A master structure can be made by e-beam writing and subsequent etching, after which spot generators can be made by a replication process. Having a single height step that works for all wavelengths involved minimizes manufacturing steps. For example, a height difference h=1.00 μm/(n−1), where n=1.5 (a typical value for the refractive index of the spot generator structure), gives rise to a phase difference of approximately 3π for λ=655 nm and 5π for λ=405 nm. Alternatively, the spot generator comprises a micro-lens array. Of course, other embodiments may be envisioned. For example, it is possible to design a periodic binary phase structure working in reflection rather than in transmission. In this case, it is the reflected wave that forms the light spots.

In one embodiment of the invention, the light spots of the first plurality differ from the light spots of the second plurality in their numerical aperture. In this embodiment the spot generator is designed such that the light leaving a particular light spot defines a light cone with opening half-angle θ and numerical aperture NA=sin θ. The first plurality of spots then has a first numerical aperture NA₁, and the second plurality of light spots then has a second numerical aperture NA₂, where NA₂ is larger than NA₂. The size of the light spots is of the order λ over NA, so that the spots in the first plurality are smaller than the spots in the second plurality. This allows for contrast modes with different resolution and thus enables a zooming functionality. Some typical numbers are found from the following considerations. The resolution R is given by:

$$\frac{1}{R} = \{ \begin{matrix}\frac{{NA}_{ill}}{λ} + \frac{{NA}_{im}}{λ} , & if {NA}_{ill} > {NA}_{im} \\ \frac{2 {NA}_{ill}}{λ} , & if {NA}_{ill} < {NA}_{im}\end{matrix}$$

where NAᵢₗₗ and NAᵢₘ are the numerical aperture of the illuminating spots and the imaging optics, respectively. For example, for NAᵢₗₗ=NA₁=0.6, and NAᵢₘ=0.4 the resolution is R₁=λ and for NAᵢₗₗ=NA₂=0.25, and NAᵢₘ=0.4 the resolution is R₂=2λ. A multi-modal spot generator generating spots with numerical apertures NA₁=0.6 and NA₂=0.25 thus allows for zooming with a factor two.

In accordance with another embodiment of the invention, the light spots of the first plurality each have a circular transversal profile of the angular spectrum and the light spots of the second plurality each have a ring-shaped transversal profile of the angular spectrum. The first plurality can be used to provide a bright-field imaging mode, while the second plurality can be used to provide a dark-field contrast. It is recalled that conventional bright field spots have an angular spectrum with essentially non-zero amplitude for angles θ between the beam and the optical axis satisfying θ<asin(NA₁), where NA₁ is the numerical aperture of the bright field spot. The dark field spots have an angular spectrum with essentially non-zero amplitude for angles θ between the beam and the optical axis satisfying asin(NA₂)<θ<asin(NA₃), where the values NA₂ and NA₃ are defined by this relation and where NA₂>NAᵢₘ (the numerical aperture of the imaging optics). Preferably NA₃=NA₁, so that the smallest resolvable details are the same in both modes. The imaging optics collects no light for a uniform object in the dark field contrast mode. Small details in a uniform background thus give the appearance of a bright structure in an otherwise dark background (hence the name dark field). This contrast mode thus has the advantage of increased contrast. In another embodiment, at least one of the pluralities of light spots generates a phase contrast. The angular spectrum of the spots is essentially the same as for the dark field case, i.e. essentially non-zero amplitude for angles θ between the beam and the optical axis satisfying asin(NA₂)<θ<asin(NA₃), only now the numerical aperture values must satisfy NA₂<NA₃<NAᵢₘ, the numerical aperture of the imaging optics. Furthermore, the imaging optics must be equipped with a phase ring in the pupil of the optical system. This phase ring adds an optical path length of λ/4 and a transmission A≦1 compared to the other pupil points. Further information on the phase contrast method can be found in [D. Stephens (editor), Cell Imaging, Scion Publishing, Bloxham, 2006].

In yet another embodiment of the invention, the light spots of the first plurality differ from the light spots of the second plurality in their luminosity. If the object has a low overall transmittance, the spots with large luminosity are advantageously used in order to enhance the visibility of weak modulations. If the object has a high overall transmittance, the spots with small luminosity are advantageously used. Thereby two modes differing in their illumination strength are provided thus enhancing the dynamic range of the image.

In yet another embodiment of the invention, the light spots of the first plurality are minimally astigmatically aberated, and the light spots of the second plurality are substantially astigmatically aberated. As a consequence, a light spot of the second plurality is split into two focal lines, preferably one above and one below the plane onto which the light spots of the first plurality are focused, such that the two lines are mutually perpendicular. When an imaging optics is focused below or above the focal plane of the first plurality of spots, the images of the second plurality of spots on the pixelated photo-detector will no longer be circular but elongated in the direction of the focal line below or above the focal plane, respectively. The direction and amount of elongation can thus be used to adjust the axial position of the imaging optics with respect to the spot generator until the first plurality of light spots is imaged sharply onto the pixelated photodetector. The first plurality of lights spots thus provides an imaging mode while the second plurality of light spots provides a servo mode for a multi-spot microscope.

According to yet another embodiment of the invention, the light spots of the first and of the second plurality differ by the wavelength λ for which the spot generator is optimized. Preferably, the spot generator is a (binary) phase structure. The phase profile imparted to the incident beam in order to generate an array of spots of a certain numerical aperture NA then depends on the wavelength of the incident light. The amplitude for composing diffraction orders is essentially non-zero for angles θ between the beam and the optical axis satisfying θ<asin(NA). Alternatively, if a micro-lens array is used to generate an array of spots, the micro-lenses will suffer from chromatic aberration so that different groups of micro-lenses within the array must be used in order to provide a scanning spot array of sufficient quality, wherein the lenses in each group are optimized for the wavelength associated with that group of spots. The illumination with the at least two lasers can be done sequentially, for example, in a pulsed manner (the pulses of the different lasers alternating), or simultaneously (most easily in a “continuous wave” manner). In the latter case the illumination may be zonal in the sense that light of a particular colour is incident only on the part of the spot generator intended for generating spots of that specific colour, or the detection light path may be supplemented with additional means for colour separation, for example with a dichroic beam splitter directing light of the first colour to one arm and light of the second colour to the other arm. A pixelated photo-detector can be placed in each arm so that the individual colours can be imaged simultaneously. This embodiment of the invention is suitable for providing colour information about the object in transmission contrast by using at least two different lasers to illuminate the spot generator. For example, using red (λ=655 nm) and blue (λ=405 nm) semiconductor laser diodes would provide a bi-chromatic image of the object. When supplemented with a third laser emitting green light, a full-colour image of the object can be acquired.

The invention further provides a multi-spot scanning microscope comprising:

a spot generator as described above,

According to an aspect the microscope further comprises:

imaging optics arranged to collect light from light spots generated by the spot generator,

a pixelated photodetector, arranged to detect light collected by the imaging optics, and

logic circuitry operationally connected to the pixelated photodetector, for analyzing light spots of either the first or the second plurality of light spots.

The microscope according to the invention can also be arranged for generating images using fluorescence contrast. In this contrast mode, light with a certain wavelength is used to illuminate the specimen, which generates light with a (slightly) larger wavelength. In order to detect this light, a wavelength-selective filter must be placed in the detection light path, preferably in between the lens components constituting the imaging optics, so as to block all light of the incidence wavelength. Alternatively, a dichroic beam splitter is inserted in the detection light path so as direct the fluorescent light into one arm and the light of the incidence wavelength to the other arm. A pixelated photo-detector can be placed in each arm so that conventional transmission contrast and fluorescence contrast can be provided simultaneously. Commonly, fluorescent agents are used to enhance the fluorescent contrast. These agents can be chemically manufactured substances that bind or accumulate at a certain region of interest in the specimen under investigation or they can be genetically encoded fluorescent proteins, which are used to investigate gene expression within cells. When using such agents, the wavelength of the laser light sources used must be optimized for the particular fluorescent agents that are used, as the efficiency for generating fluorescence depends on the incident wavelength.

Preferably, the logic circuitry is connected to a PC. The logic circuitry may be designed such that it transmits signals from only a selected plurality of light spots, or alternatively it may be designed such that it deliver signals from both the first and the second plurality of light spots. In the latter case the selection between the two pluralities is performed on the PC.

Preferably, the multi-spot scanning microscope comprises a coherent light source for generating the light beam. In fact the simplest designs of the spot generator according to the invention are such that the spot generator will work only for a restricted range of wavelength. Therefore it is advantageous to generate the light beam choosing a coherent light source integrated in the multi-spot scanning microscope and having the wavelength for which the spot generator is designed.

In a preferred embodiment of the invention, the multi-spot scanning microscope is designed to generate the first plurality and the second plurality of light spots simultaneously. This can be achieved by using a spot generator comprising an array of identical unit cells for generating both the first and the second plurality of light spots, as described above. It can also be achieved by illuminating simultaneously a first section and a second section of the spot generator, such that the first section of the spot generator generates the first plurality of light spots and the second section of the spot generator generates the second plurality of light spots.

Alternatively, the multi-spot scanning microscope is designed to generate the first plurality and the second plurality of light spots sequentially. Such a design can be advantageous to avoid noise or other errors induced by the light that generates one plurality of light spots when one wishes to image the light spots of the other plurality.

The invention further provides a method of imaging a sample, in particular a microscopic sample, comprising the steps of:

generating simultaneously a first plurality (22) and a second plurality (24) of separate light spots for illuminating the sample, wherein each light spot belonging to the first plurality has a first angular spectrum and each light spot belonging to the second plurality has a second angular spectrum different than the first angular spectrum;

generating an image of the sample on a pixelated photodetector;

selectively analyzing light spots of either the first plurality or the second plurality.

Generating the first plurality and the second plurality of separate light spots simultaneously has the advantage that switching between a first imaging mode and a second imaging mode can be done in software alone, without mechanically changing optical elements.

It has to be noted here that by “illuminating the sample”, it has to be understood in the present invention that it encompasses a configuration where the spots are focused in the sample as well as a configuration where the spots are focused at the surface of this sample. In the following description, the term in will refer indistinctively to both these configurations.

### BRIEF DESCRIPTION OF THE DRAWINGS

Other aspects, purposes and advantages of the invention will become clearer upon reading the following detailed description of a preferred embodiment of the latter, given by way of non restrictive example and made in reference to the annexed drawings, in which:

FIG. 1 is a schematic view of a generic multi-spot scanning microscope.

FIG. 2 is a schematic bottom view of an array of light spots generated by a prior-art multi-spot scanning microscope;

FIGS. 3, 4, and 6 are schematic bottom views of arrays of light spots generated by the spot generator according to the invention;

FIG. 5 is a schematic side view of the array of light spots shown in FIG. 4, and of the spot generator generating the array;

FIG. 7 is a bottom view of a unit cell of a binary phase structure for generating light spots having a ring-shaped profile.

### DESCRIPTION OF PREFERRED EMBODIMENTS

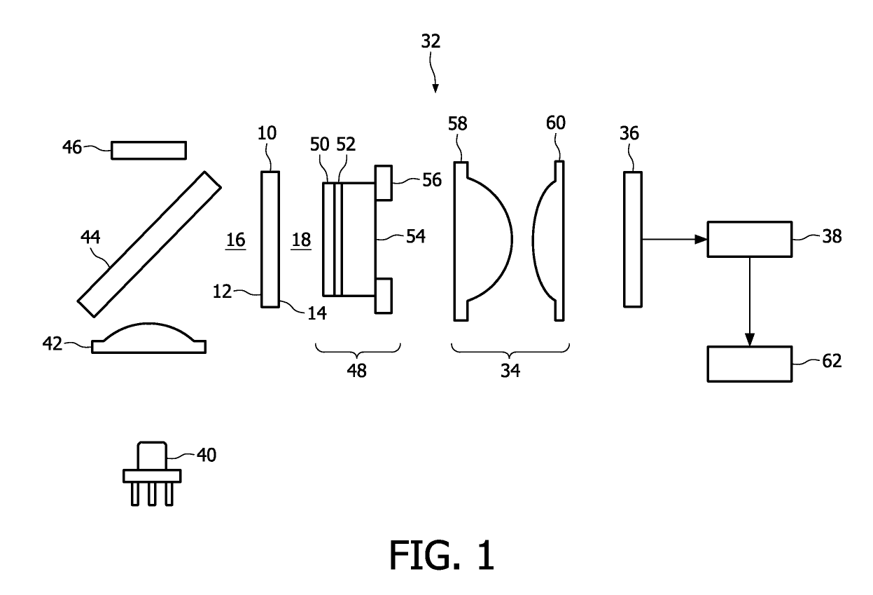

FIG. 1 illustrates the general build-up of a generic multi-spot scanning microscope. The microscope comprises a laser 40, a collimator lens 42, a beam splitter 44, a forward-sense photodetector 46, a spot generator 10, a sample assembly 48, imaging optics 34, a pixelated photodetector 36, a video processing integrated circuit (IC) 38, and a personal computer (PC) 62. The spot generator 10 has an entry surface 12 defining an entry side 16 and an exit surface 14 defining an exit side 18. The sample assembly 48 consists of a cover slip 50, a sample layer 52, a microscope slide 54, and a scan stage 56. The cover slip 50, the sample layer 52, and the microscope slide 54 are placed on the scan stage 56. The laser 40 emits a coherent light beam that is collimated by the collimator lens 42 and split by the beam splitter 44 into a transmitted part and into a reflected part. The transmitted part of the light is captured by the forward-sense photodetector 46 for measuring the light output. This measurement is used by a laser driver (not shown) to control the laser's 40 light output. The reflected part of the light is incident on the entry surface 12 of the spot generator 10. The light is modulated by the spot generator 10 such that the transmitted light generates on the exit side 18 an array of light spots. The distance between the spot generator 10 and the sample layer 52 is chosen such that the array of light spots is generated within the sample layer 52. The scan stage 56 is provided with means for scanning the microscope slide 54, and with it the sample, through the array of light spots generated by the spot generator 10. The imaging optics 34, comprising lenses 58 and 60, makes an image of the sample layer 52 illuminated by the array of light spots generated by the spot generator 10 on the pixelated photodetector 36. The captured images are processed by the video processing IC 38 to the actual microscopic image that is displayed and possibly analyzed by the PC 62.

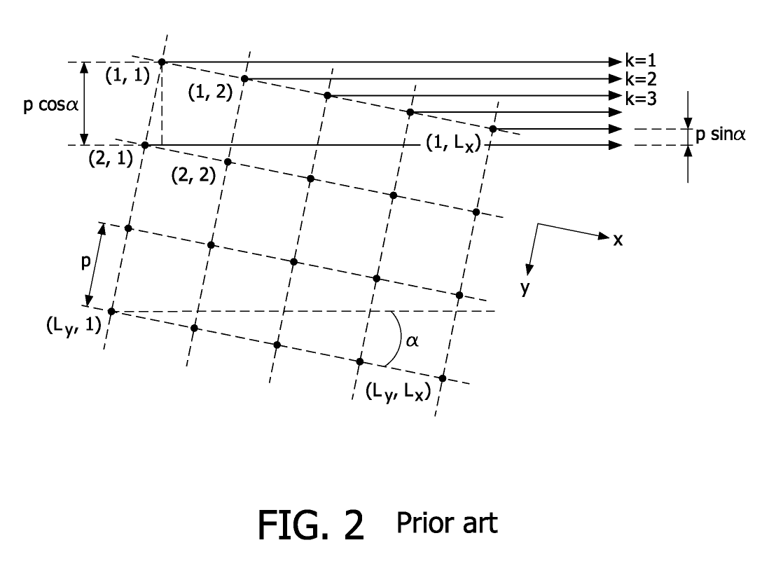

Turning now to FIG. 2, there is shown an array of light spots generated by a prior-art spot generator. The array defines an x-y-plane which is perpendicular to the propagation direction of the light from which the light spots are generated. The light spots composing the array all lie in the x-y-plane. The array forms a quadratic lattice, with a lattice pitch p. The light spots are labelled (I, J), where I and J respectively refer to the x and y coordinates. The light spots are scanned with respect to the sample in a scanning direction having an angle α with respect to the x-axis defined by the array of light spots. Thus each light spot scans the sample along a distinct straight line (K=1, 2, 3) with the distance between two adjacent trajectories (e.g., K=1 and K=2) being significantly shorter than the lattice pitch P.

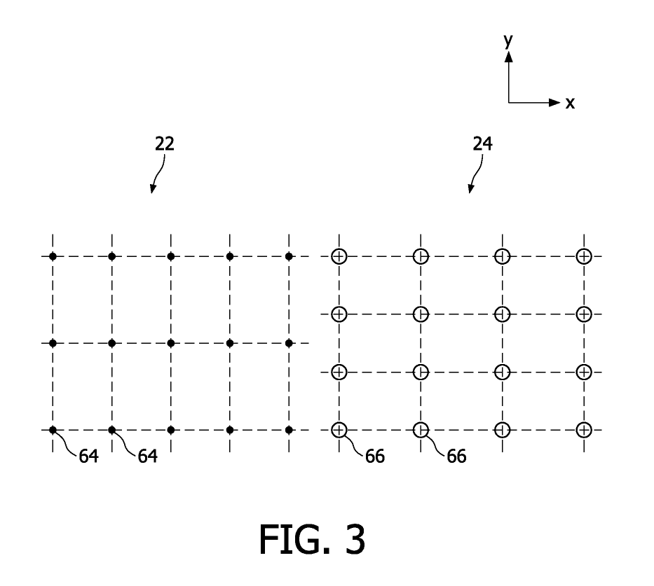

FIG. 3 schematically illustrates an array of light spots generated by a multi-modal spot generator according to a first embodiment of the invention. The spot generator generates a first plurality 22 and a second plurality 24 of light spots situated in an x-y-plane, where the z-axis is taken parallel to the propagation direction of the mean propagation direction of the light on the spot generator's exit side. The first plurality 22 forms a regular rectangular array of identical light spots 64. The second plurality 24 forms in this embodiment a rectangular array of identical light spots 66. Note that the arrays 22 and 24 are adjacent. The layout of the spot generator generating the pluralities of light spots 22, 24 is strictly analogous to the layout of the arrays shown in the Figure. That is, the spot generator comprises a first section for generating the plurality of light spots 22 and an adjacent second section for generating the second plurality 24. Each section of the spot generator may for example be a micro-lens array or a binary phase structure. The light spots 64 of the first plurality 22 differ essentially from the light spots 66 of the second plurality 24 in their angular spectrum. Note that both arrays may be decomposed into identical rectangular unit cells. The general layout of the spot generator is identical to the layout of the arrays 22, 24, that is, the spot generator comprises two adjacent arrays, each composed of identical unit cells, such that there is a one-to-one mapping between unit cells of the spot generator and unit cells of the array of light spots.

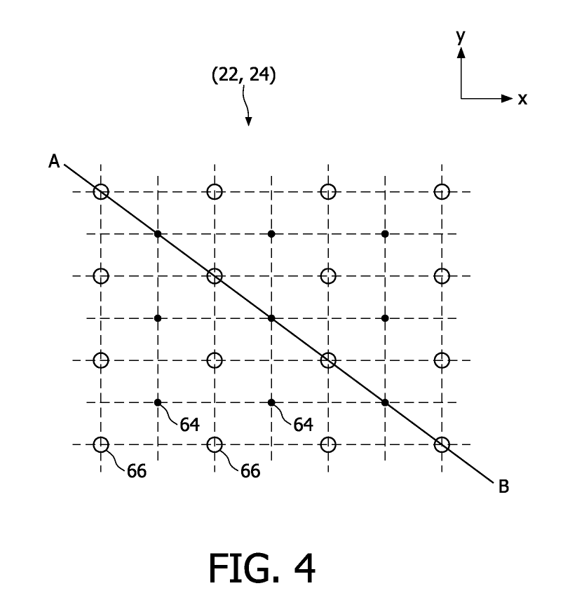

Referring now to FIG. 4, there is schematically illustrated an array of light spots according to another embodiment of the spot generator. The array of light spots comprises a first sub-array 22 and a second sub-array 24. Note that the combined array 22, 24 can be decomposed into identical unit cells, each unit cell comprising a light spot 64 of the first array 22 and a light spot 66 of the second array 24. The arrays 22 and 24 are thus interlaced. The spot generator used to generate this array has the same general layout as the array itself, that is, it also consists of identical unit cells, where each unit cell of the spot generator maps exactly on one unit cell of the array 22, 24.

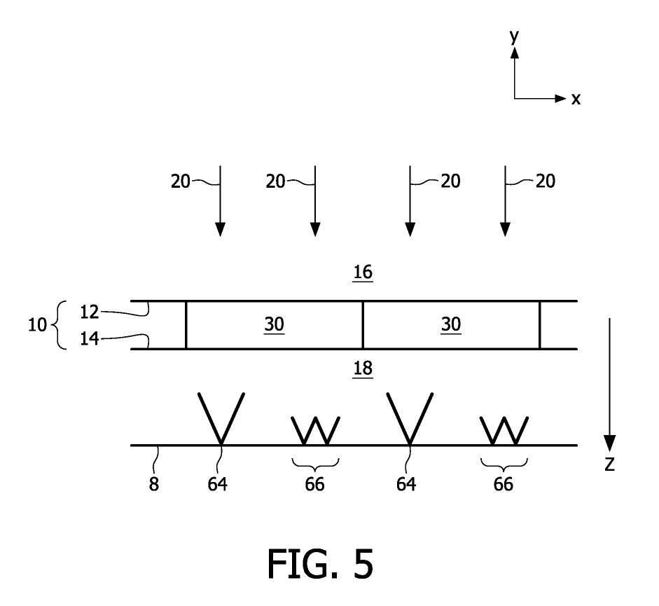

Referring now to FIG. 5, there is illustrated a sectional view of a spot generator 10 generating the arrays 22, 24 shown in FIG. 4, along the line AB of FIG. 4. Coherent light 20 is incident onto an entry surface 12 of the spot generator 10. The entry surface 12 of the spot generator 10 defines an entry side 16, and the exit surface 14 of the spot generator defines an exit side 18. The light 20 is modulated by the spot generator 10 in such a way that on the exit side 18 the light forms two pluralities of light spots, namely a first plurality of light spots comprising identical light spots 64 and a second plurality of light spots comprising identical light spots 66, wherein the light spots 66 of the second plurality differ in their angular spectrum from the light spots 64 of the first plurality. The light spots 64 of the first plurality and the light spots 66 of the second plurality lie in a common focal plane 8 perpendicular to the z-direction. The light spots 64 of the first plurality and the light spots 66 of the second plurality may, for example, provide a bright field and a dark field imaging mode, respectively, where every light spot 64 for the bright field mode has an intensity maximum at its centre, whereas every light spot 66 for the dark field mode has an intensity minimum at its centre, the centre being surrounded by a circular ring of high intensity. The ring profile of the dark field spots 66 would become fully apparent when looking into the z-direction as in FIG. 4.

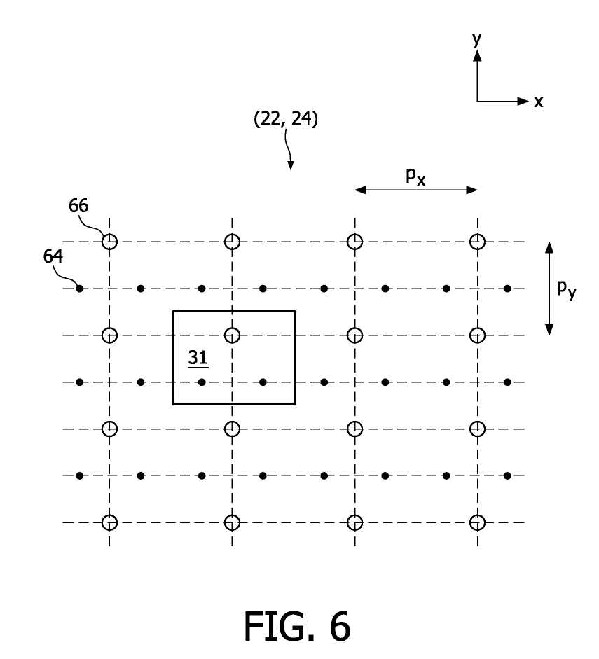

Referring now to FIG. 6, there is schematically shown an array of light spots comprising a sub-array of large spots 66 for generating low-resolution images and a sub-array of small spots 64 for generating high-resolution images. This layout of scanning spots is appropriate for simultaneous acquisition of images with resolutions differing by a factor of 2. Both sub-arrays may be decomposed into rectangular unit cells. The area of the cross section of the large spots 66 is about four times as large as the area of the cross section of the small spots 64. The spots are arranged in evenly spaced parallel rows, each row extending in the x-direction, with a spacing of p_{y}/2. The sequence of rows alternates between rows of small spots and rows of large spots. Within each row of small spots 64 along the x-direction, the spacing between light spots 64 is pₓ/2, whereas within each row of large spots 66 along the x-direction, the spacing between light spots 64 is pₓ. There are thus twice as many small spots as large spots. The combined array 22, 24 can be decomposed into identical unit cells 31, each unit cell containing one large spot and two small spots. As in the other embodiments discussed above, there is a one-to-one mapping between the unit cells 31 of the array of light spots and unit cells of the spot generator that generates the light spots. The light spots shown in FIG. 6 are arranged such that switching between modes (i.e. selecting either the large spots 66 or the small spot 64) does not require any mechanical changes in the position or orientation of microscope components. In particular, the angle α between the spot array and the scanning direction (see FIG. 2) does not need to be changed.

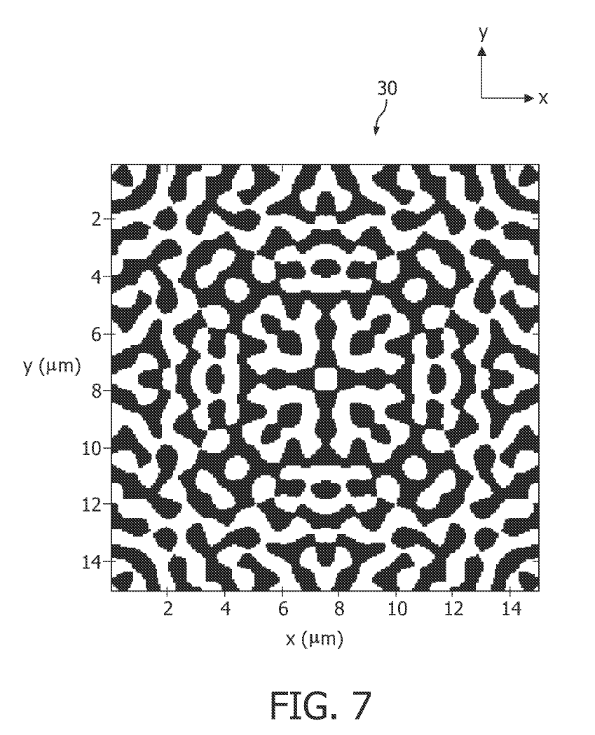

Finally, FIG. 7 illustrates a unit cell 30 of a binary phase structure for generating an array of light spots, wherein each light spot has a ring-shaped transversal profile of the angular spectrum, for providing a dark-field contrast modus. The unit cell 30 is a square transparent plate, with each edge measuring 15 micrometers. The thickness of the plate is restricted to two possible values at any given point of the area. Areas of a first thickness are indicated black; areas of a second thickness are indicated white.

Although the present invention has been described above with reference to specific embodiment, it is not intended to be limited to the specific form set forth herein. Rather, the invention is limited only by the accompanying claims and, other embodiments than the specific above are equally possible within the scope of these appended claims.

For example, even though it has been mentioned above to analyze selectively either the first or the second plurality of light spots, the present invention also encompass an analysis of both pluralities at the same time.

In the claims, the term “comprises/comprising” does not exclude the presence of other elements or steps. Furthermore, although individually listed, a plurality of means, elements or method steps may be implemented by e.g. a single unit or processor. Additionally, although individual features may be included in different claims, these may possibly advantageously be combined, and the inclusion in different claims does not imply that a combination of features is not feasible and/or advantageous. In addition, singular references do not exclude a plurality. The terms “a”, “an”, etc do not preclude a plurality. Reference signs in the claims are provided merely as a clarifying example and shall not be construed as limiting the scope of the claims in any way.

1. A spot generator (10) having:
an entry surface (12) for receiving an incident light beam (20), and
an exit surface (14) for transmitting the light beam,
the entry surface defining an entry side (16) and the exit surface defining an exit side (18), wherein the spot generator is designed to modulate the incident light beam to generate on the exit side a first plurality (22) and a second plurality (24) of separate light spots, each light spot belonging to the first plurality having a first angular spectrum and each light spot belonging to the second plurality having a second angular spectrum different than the first angular spectrum.

2. The spot generator (10) as claimed in claim 1, wherein the light spots of the first plurality (22) and the light spots of the second plurality (24) lie in a common focal plane.

3. The spot generator (10) as claimed in claim 1, wherein every light spot generated on the exit side (18) by the spot generator (10) differs from every other light spot generated on the exit side by the spot generator in the projection of its position on a plane essentially perpendicular to the mean propagation direction of the transmitted light beam (20).

4. The spot generator (10) as claimed in claim 1, wherein the spot generator comprises a first section (26) for generating light spots of the first plurality (22) and a second section (28) for generating light spots of the second plurality.

5. The spot generator (10) as claimed in claim 1, wherein the spot generator (10) comprises an array of identical unit cells (30) for generating both the first and the second plurality of light spots (22, 24).

6. The spot generator (10) as claimed in claim 1, wherein the spot generator (10) comprises a periodic binary phase structure.

7. The spot generator (10) as claimed in claim 1, wherein the light spots of the first plurality (22) differ from the light spots of the second plurality (24) in their numerical aperture.

8. The spot generator (10) as claimed in claim 1, wherein the light spots of the first plurality (22) each have a disk-shaped transversal profile of the angular spectrum and the light spots of the second plurality (24) each have a ring-shaped transversal profile of the angular spectrum.

9. The spot generator (10) as claimed in claim 1, wherein the light spots of the first plurality (22) differ from the light spots of the second plurality (24) in their luminosity.

10. The spot generator (10) as claimed in claim 1, wherein the light spots of the first plurality (22) are minimally astigmatically aberrated and the light spots of the second plurality (24) are substantially astigmatically aberrated.

11. A multi-spot scanning microscope (32) comprising a spot generator (10) according to claim 1.

12. The multi-spot scanning microscope (32) according to claim 11, further comprising:
imaging optics (34) arranged to collect light (20) from light spots (22, 24) generated by the spot generator (10),
a pixelated photodetector (36) arranged to detect light (20) collected by the imaging optics, and
logic circuitry (38) operationally connected to the pixelated photodetector, for selectively analyzing either the first (22) or the second plurality (24) of light spots.

13. The multi-spot scanning microscope (32) as claimed in claim 11, wherein the microscope (32) is designed to generate the first plurality (22) and the second plurality (24) of light spots simultaneously.

14. The multi-spot scanning microscope (32) as claimed in claim 11, wherein the microscope (32) is designed to generate the first plurality (22) and the second plurality (24) of light spots sequentially.

15. A method of imaging a sample, in particular a microscopic sample, comprising the steps of:
generating simultaneously a first plurality (22) and a second plurality (24) of separate light spots for illuminating the sample, wherein each light spot belonging to the first plurality has a first angular spectrum and each light spot belonging to the second plurality has a second angular spectrum different than the first angular spectrum;
generating an image of the sample on a pixelated photodetector (36);
selectively analyzing light spots of either the first plurality (22) or the second plurality (24).
